(19) United States
(12) Patent Application Publication
(10) Pub. No.: US 2025/0375775 A1
(43) Pub. Date: Dec. 11, 2025

(54) ULTRA-THIN MICRO-ELECTROSTATIC MODULE AND PRODUCTION METHOD THEREOF

(71) Applicant: AirQuality Technology (Shanghai) Co., Ltd., Shanghai (CN)

(72) Inventors: Shanqing MENG, Shanghai (CN); Lisun WANG, Shanghai (CN); Shidan LONG, Shanghai (CN)

(21) Appl. No.: 19/013,478

(22) Filed: Jan. 8, 2025

Related U.S. Application Data
(63) Continuation of application No. PCT/CN2024/132600, filed on Nov. 18, 2024.

(30) Foreign Application Priority Data
Jun. 7, 2024 (CN) 2024107398441

(51) Int. Cl. B03C 3/82; B03C 3/51; B23P 15/00

(52) U.S. Cl. CPC B03C 3/82; B03C 3/51; B23P 15/00

(57) ABSTRACT

The present application provides an ultra-thin micro-electrostatic module and a production method. The ultra-thin micro-electrostatic module includes a micro-electrostatic module core, wherein the micro-electrostatic module core comprises a plurality of air channels for air circulation and is provided with a fixing groove; a frame body comprising a plurality of frames arranged corresponding to the micro-electrostatic module core, wherein the micro-electrostatic module core is accommodated in the frame body; and a fixing component, wherein the fixing component is embedded in the fixing groove, and is connected with the frame body and the micro-electrostatic module core to fix the micro-electrostatic module core. The ultra-thin micro-electrostatic module in the present application solves the technical problem that the outer frame of the micro-electrostatic module occupies the size in the thickness direction, resulting in the loss of purification efficiency and dust holding capacity.

### CROSS-REFERENCE TO RELATED APPLICATIONS

This application claims priority to Chinese Patent Application No. 2024107398441, titled "ULTRA-THIN MICRO-ELECTROSTATIC MODULE AND PRODUCTION METHOD THEREOF", filed on June 7, 2024, the entire disclosure of which is incorporated herein by reference.

### TECHNICAL FIELD

The present application relates to the technical field of micro-electrostatic technology, and in particular to an ultra-thin micro-electrostatic module and a production method thereof.

### REARGROUND

At present, the mainstream air purification technology is divided into medium filtration technology and electrostatic purification technology. The medium filtration technology is mature and relatively stable, but it has high wind resistance, high fan energy consumption, easy breeding of bacteria and viruses, inability to sterilize and disinfect, produces odor, needs to be replaced frequently, generates a large number of consumables, has high operation and maintenance costs, no energy saving and no environmental protection. Electrostatic purification technology can remove particles, sterilize and disinfect, have low resistance, and can be washed repeatedly. However, due to its low purification efficiency, high relative power, easy ignition, high ozone, poor safety, short service life, heavy weight and high maintenance cost, not energy-saving or environmentally friendly, it can not be widely popularized and applied in the field of light pollution air purification, and can only be used in few scenes. Micro-electrostatic technology is compatible with the advantages of medium filtration technology and electrostatic purification technology, taking into account high-efficiency purification and dust removal, sterilization and disinfection, and has the technical advantages of ultra-low power, low resistance, high humidity resistance, high safety, repeated cleaning, no consumables and service life of up to 10 years.

However, the micro-electrostatic module used in the existing micro-electrostatic technology has an outer frame, which occupies the size in the thickness direction. In the scene where the installation space is limited, the thickness of the die core of the micro-electrostatic module is reduced because it cannot be fully utilized in the thickness direction, resulting in efficiency loss and dust capacity loss.

Therefore, the existing technology needs further development.

### SUMMARY

This application addresses the limitations of current technology by presenting an ultra-thin micro-electrostatic module and a production method, so as to solve the technical problem that in the related art, the micro-electrostatic module occupies the size in the thickness direction, resulting in the loss of purification efficiency and dust holding capacity.

To achieve the above purpose, the present application adopts the following technical solutions.

An ultra-thin micro-electrostatic module, including:

a micro-electrostatic module core, the micro-electrostatic module core includes a plurality of air channels for air circulation, and the micro-electrostatic module core is provided with a fixing groove; a frame body including a plurality of frames arranged corresponding to the micro-electrostatic module core, the micro-electrostatic module core is accommodated in the frame body; and

a fixing component, wherein the fixing component is embedded in the fixing groove, and is connected with the frame body and the micro-electrostatic module core to fix the micro-electrostatic module core.

In an embodiment, the fixing component includes a boss integrally formed with the frames, and the boss extends in a direction close to the micro-electrostatic module core and is embedded in the fixing groove.

In an embodiment, the fixing groove includes a first connection surface and a second connection surface connected with the first connection surface, and the extending directions of the first connection surface and the second connection surface are perpendicular to each other.

The second connecting surface is an arc surface.

In an embodiment, the fixing groove includes a first connection surface, and the first connection surface is an inclined surface.

The first connecting surface is an arc surface.

In an embodiment, the micro-electrostatic module core includes a first dust collecting surface and a second dust collecting surface arranged oppositely, and a plurality of air channels for air circulation are arranged between the first dust collecting surface and the second dust collecting surface. The first dust collecting surface is arranged to protrude from one of the plurality of frames along extending direction of the plurality of air channels.

The second dust collecting surface is arranged to protrude from the plurality of frames along the extending direction of the plurality of air channels.

In an embodiment, the fixing component includes an insulating glue, and the insulating glue is filled between one of the plurality of frames and the fixing groove.

In an embodiment, the micro-electrostatic module core includes a plurality of dust collecting sheets in a stacked arrangement and a plurality of spacers, each of the plurality of spacers is arranged between two of the plurality of dust collecting sheets, the plurality of air channels is formed between the dust collecting sheets and the plurality of spacers, one of the dust collecting sheets is wrapped with a conductive material, the conductive material comprises an avoidance groove, and the avoidance groove is arranged corresponding to the fixing groove.

In an embodiment, the conductive material is electrically connected to a high-voltage power supply through a electrode strip, and the high-voltage power supply is installed inside the frame body or outside the frame body.

In an embodiment, the ultra-thin micro-electrostatic module further including a plurality of fixing components, wherein the plurality of fixing components are arranged corresponding to the plurality of frames; and a plurality of fixing grooves.

In an embodiment, the fixing component includes a first fixing component and a second fixing component arranged at intervals, and the first fixing component is connected with a end of one of the plurality of frames, and the second fixing component is connected with a end of one of the plurality of frames far away from the first fixing component.

The fixing groove includes a first fixing groove and a second fixing groove arranged at intervals, and the first fixing groove is arranged corresponding to the first fixing component, and the second fixing groove is arranged corresponding to the second fixing component.

In an embodiment, the fixing groove includes a first fixing groove arranged on a leeward surface of the micro-electrostatic module core, and the boss is embedded in the first fixing groove to support the micro-electrostatic module core.

A production method, and the production method is suitable for the ultra-thin micro-electrostatic module according, and the production method includes:

obtaining a micro-electrostatic module core;

machining a fixed groove on the micro-electrostatic module core, and melting is generated in the fixed groove through a high temperature generated in the machining process;

connecting a plurality of frames with the micro-electrostatic module core correspondingly in turn;

embedding the fixing component in the fixing groove; and

completing the assembly of the ultra-thin micro-electrostatic module.

In an embodiment, the machining a fixed groove on the micro-electrostatic module core includes:

fixing the micro-electrostatic module core on a thermal cutting device; and

processing the fixing groove through thermal cutting.

Beneficial effects of the present application:

1. The ultra-thin micro-electrostatic module in the embodiment of this application improves the dust holding capacity and purification efficiency of the micro-electrostatic module, reduces the use cost of the filter element, solves the sealing problem of the micro-electrostatic module by adopting the thermal cutting process, and ensures that the ultra-thin micro-electrostatic module in the embodiment of this application has an ideal waterproof effect.

2. By arranging the fixing components, the fixing components are embedded in the fixing grooves and respectively connected with the frame body and the micro-electrostatic module core, so that the micro-electrostatic module core is fixed on the frame body, and the installation of the micro-electrostatic module core is completed; and by arranging the fixing grooves on the micro-electrostatic module core and forming a step structure on the frame body, the step structure and the fixing grooves are mutually locked and fixed with each other, so that the micro-electrostatic module core is fixed, the dust-containing surface required for fixing the micro-electrostatic module core is reduced, the connecting area between the outer frame and the the micro-electrostatic module core is reduced, and the overall thickness of the outer frame is reduced, the structural design of the ultra-thin outer frame is realized, the dust holding capacity of the micro-electrostatic module is improved, the use cost of the filter element is reduced, the purification efficiency is improved, and the technical problem that the purification efficiency and the dust holding capacity of the micro-electrostatic module are lost because the outer frame of the micro-electrostatic module occupies the size in the thickness direction in the related art is solved.

3. In the ultra-thin micro-electrostatic module in the embodiment of this application, the air first passes through the windward side of the micro-electrostatic module and then passes through the leeward side of the micro-electrostatic module. In order to increase the structural strength of the micro-electrostatic module core, the fixing component adopts the structural design of a boss, that is, the first fixing groove is formed on the leeward side of the micro-electrostatic module core, and the fixing component is engaged with the first fixing groove by the boss, the micro-electrostatic module core is pushed against the boss structure by wind pressure, which plays a good supporting role, reduces the use of frame materials and reduces the difficulty of assembly, can prevent the micro-electrostatic module core from being deformed and detached from the frame body, and ensures the assembly strength and stability of the micro-electrostatic module core.

### BRIEF DESCRIPTION OF THE DRAWINGS

FIG. 1 is a partial view of ultra-thin micro-electrostatic module according to an embodiment of the present application.

FIG. 2 is a structural schematic diagram of the first embodiment of the ultra-thin micro-electrostatic module according to the present application.

FIG. 3 is a structural schematic diagram of the second embodiment of the ultra-thin micro-electrostatic module according to the present application.

FIG. 4 is a structural schematic diagram of the third embodiment of the ultra-thin micro-electrostatic module according to the present application.

FIG. 5 is a structural schematic diagram of the fourth embodiment of the ultra-thin micro-electrostatic module according to the present application.

FIG. 6 is a structural schematic diagram of the fifth embodiment of the ultra-thin micro-electrostatic module according to the present application.

FIG. 7 is a structural schematic diagram of the dust collecting sheet of the ultra-thin micro-electrostatic module according to an embodiment of the present application.

FIG. 8 is a structural schematic diagram of the first fixing component of the ultra-thin micro-electrostatic module according to an embodiment of the present application.

### DETAILED DESCRIPTION OF THE EMBODIMENTS

In order to enable those in the technical field better understand the solutions of the present application, the technical solutions in the embodiment of the present application will be described clearly and completely with the attached drawings. Obviously, the described embodiment is only a part of the embodiment of the present application, but not the whole embodiment. Based on the embodiment in this application, all other embodiment obtained by ordinary technicians in this field without creative work should belong to the protection scope of this application.

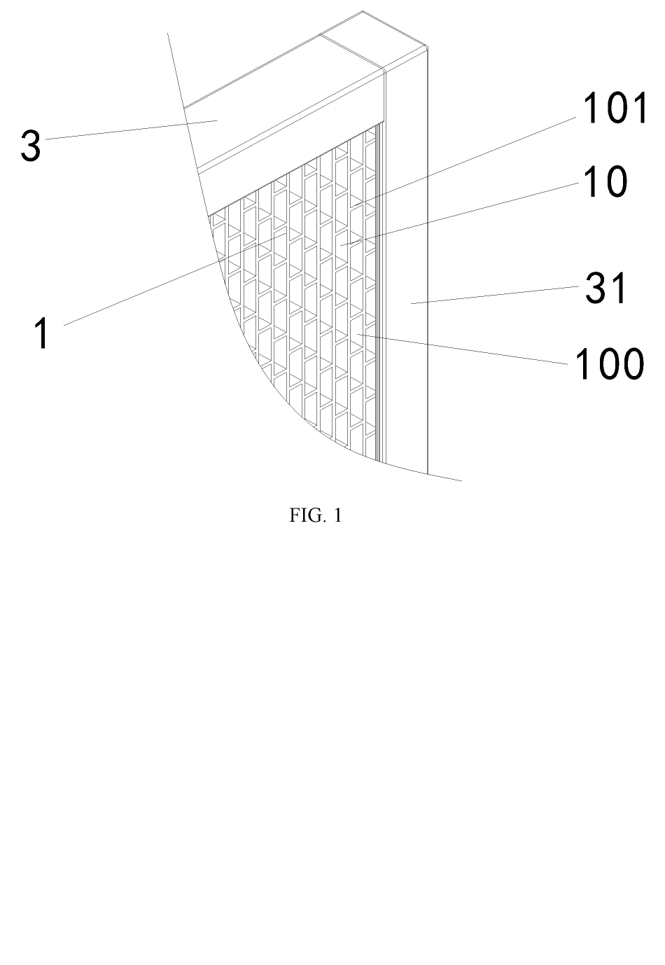

According to an embodiment of the present application, an ultra-thin micro-electrostatic module is provided, referring to FIGS. 1 to 8, and includes a micro-electrostatic module core 1, and the micro-electrostatic module core 1 includes a plurality of air channels 10 for air circulation, and the micro-electrostatic module core 1 is provided with a fixing groove 2; a frame body 3 including a plurality of frames 31 arranged corresponding to the the micro-electrostatic module core module core 1, and the the micro-electrostatic module core module core 1 is accommodated in the frame body 3; the fixing component 4 is embedded in the fixing groove 2 and is connected with the frame body 3 and the micro-electrostatic module core 1 to fix the micro-electrostatic module core 1.

The fixing component 4 is embedded in the fixing groove 2 and connected with the frame body 3 and the micro-electrostatic module core 1 respectively, so that the micro-electrostatic module core 1 is fixed on the frame body 3, and the installation of the micro-electrostatic module core 1 is completed; the fixing groove 2 is formed on the micro-electrostatic module core 1, and a step structure is formed on the frame body 3, so that the step structure and the fixing groove 2 are mutually locked and fixed with each other, and the micro-electrostatic module core 1 is fixed. The dust-containing surface required for fixing the micro-electrostatic module core is reduced, the connection area between the outer frame and the micro-electrostatic module core is reduced, the overall thickness of the outer frame is reduced, the structural design of the ultra-thin frame is realized, the dust-containing capacity of the micro-electrostatic module is improved, the use cost of the filter core is reduced, the purification efficiency is improved, and the technical problem that the micro-electrostatic module loses the purification efficiency and the dust-containing capacity because the outer frame occupies the size in the thickness direction in the related art is solved.

The ultra-thin micro-electrostatic module in the embodiment of this application improves the dust holding capacity and purification efficiency of the micro-electrostatic module, reduces the use cost of the filter element, solves the sealing problem of the micro-electrostatic module by adopting the thermal cutting process, and ensures that the ultra-thin micro-electrostatic module in the embodiment of this application has an ideal waterproof effect.

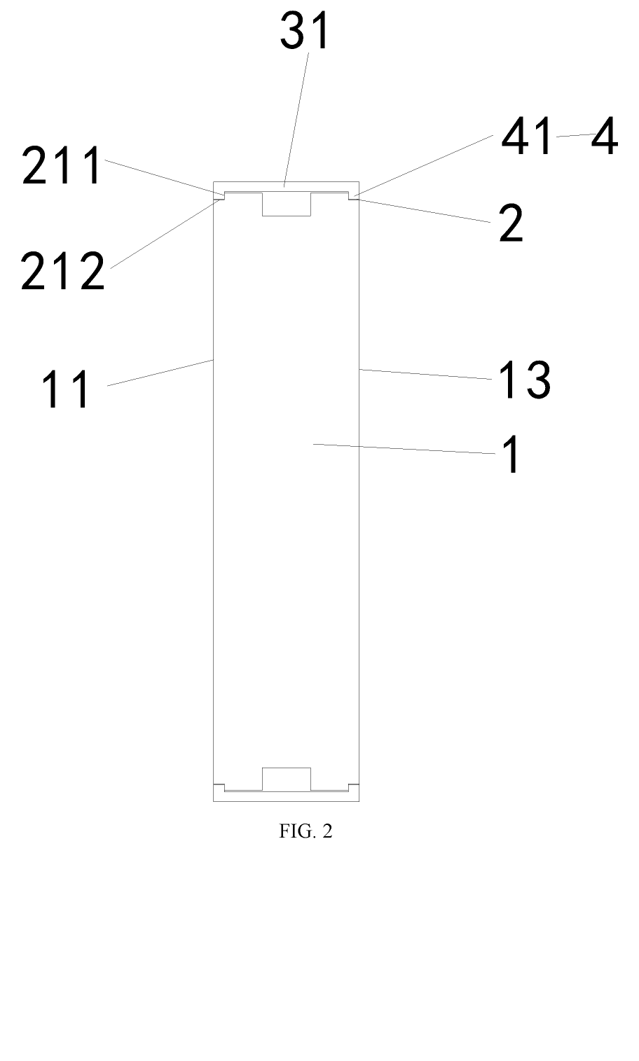

In the ultra-thin micro-electrostatic module of some embodiments, as shown in FIG. 2, the fixing component 4 includes a boss 41 integrally formed with the frame 31, and the boss 41 extends in the direction close to the micro-electrostatic module core 1, and the boss 41 is embedded in the fixing groove 2. By arranging the boss 41, the boss 41 is embedded in the fixing groove 2, and the boss 41 is engaged with the fixing groove 2 to increase the supporting force of the fixing component 4 to the micro-electrostatic module core 1, and the micro-electrostatic module core is stopped and fixed by the boss 41, so that the dust-containing surface of the micro-electrostatic module core occupied by the frame 31 is reduced and the thickness of the frame is reduced.

In some embodiments, the boss 41 is an L-shaped boss.

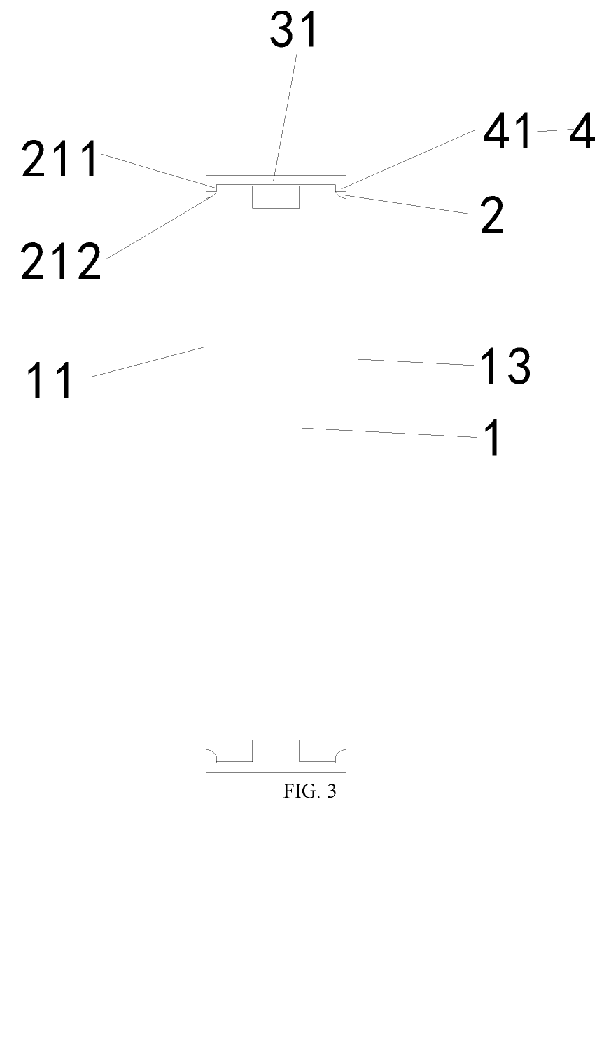

In the ultra-thin micro-electrostatic module of some embodiments, referring to FIGS. 2-3 the fixing groove 2 includes a first connection surface 211 and a second connection surface 212 that are connected with each other.

Specifically, the fixing groove 2 is formed on the side wall of the micro-electrostatic module core 1, so as to increase the wrapping property of the frame body 3 and the fixing component 4 to the micro-electrostatic module core and improve the fixing strength of the micro-electrostatic module core.

It can be understood that the fixing groove 2 can also be formed on the end surface of the micro-electrostatic module core 1, and spaced from the electrode groove located on the end surface, so that the dust-containing surface of the micro-electrostatic module core can reach the maximum.

In the ultra-thin micro-electrostatic module of some embodiments, referring to FIG. 2, the extending directions of the first connection surface 211 and the second connection surface 212 are perpendicular to each other.

Specifically, the fixing groove 2 has an L-shaped structure and is locked and fixed with the boss 41. By adopting the L-shaped fixing groove 2, the opening area of the fixing groove 2 can be reduced, and the dust-containing surface of the micro-electrostatic module core 1 can be increased. In addition, the boss 41 and the L-shaped fixing groove 2 are attached to each other, which reduces the possibility of deformation of the frame 31 and improves the structural strength of the frame 31.

In the ultra-thin micro-electrostatic module of some embodiments, referring to FIG. 3, the second connection surface 212 is an arc surface.

Specifically, by setting the second connection surface 212 as an arc surface, after the frame body 3 and the micro-electrostatic module core 1 are assembled, there is still a gap in the fixing groove 2 except the boss 41, and at this time, insulating glue can be injected to increase the stability of assembly, and at the same time, the sealing effect of the micro-electrostatic module core is increased to prevent the conductive material in the micro-electrostatic module core from leakage discharge.

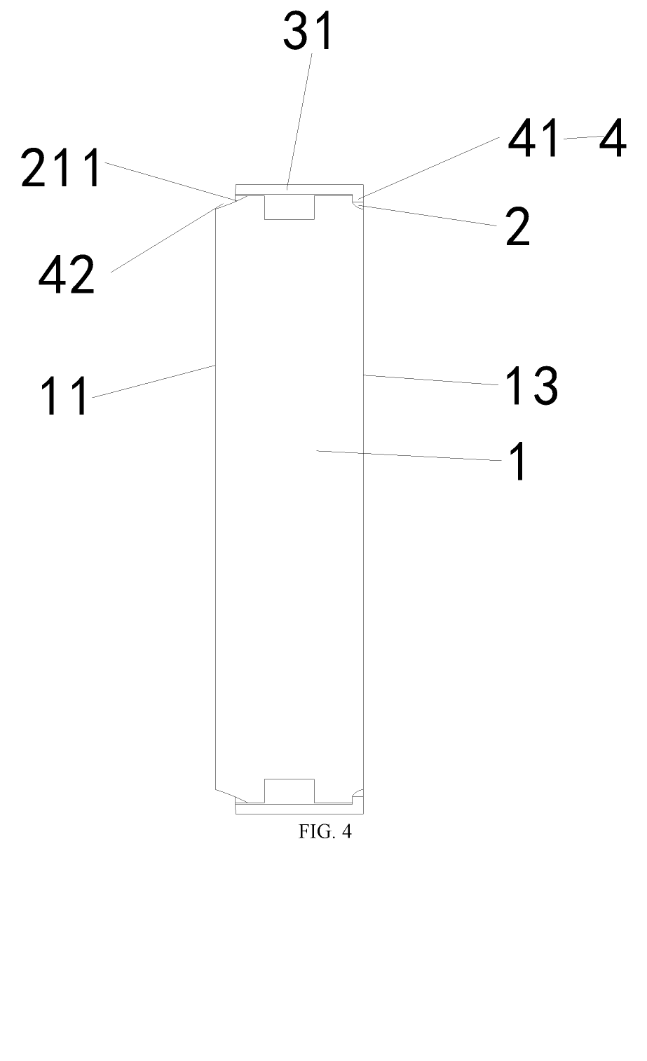

In the ultra-thin micro-electrostatic module of some embodiments, referring to FIGS. 4-6, the fixing groove 2 includes a first connection surface 211, and the first connection surface 211 is an inclined surface.

Specifically, the fixing groove 2 is opened on the side wall of the micro-electrostatic module core 1. By using a single-sided fixing groove 2, the cross-sectional area and capacity of the fixing groove 2 can be reduced, and the amount of insulating glue used for filling can be reduced, while the size of the avoidance groove 104 is reduced, and the available area of the conductive material 103 is increased.

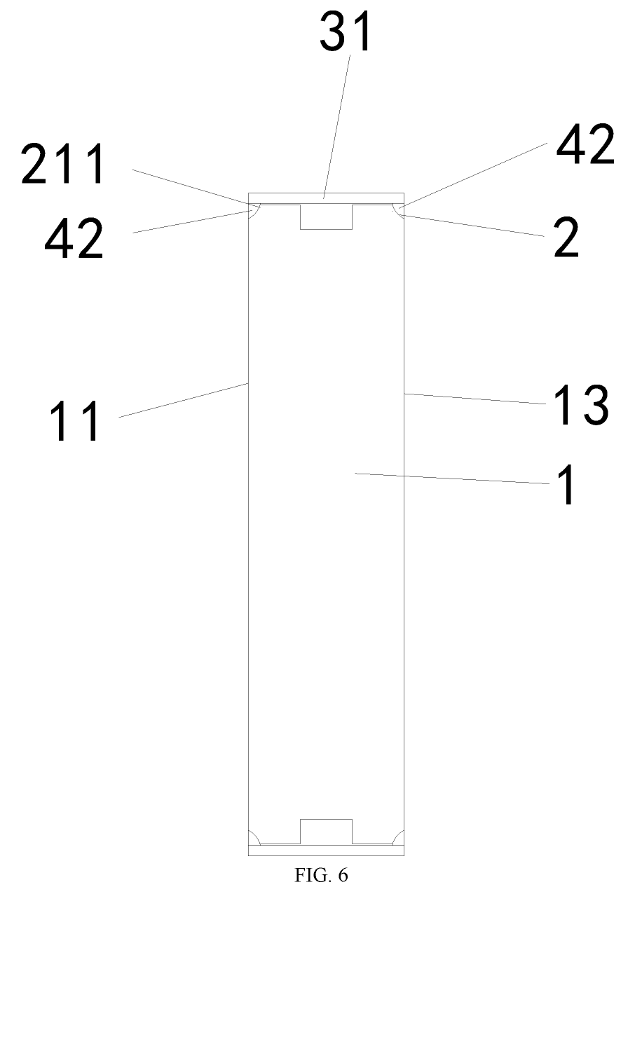

In the ultra-thin micro-electrostatic module of some embodiments, referring to FIG. 6, the first connection surface 211 is an arc surface.

Specifically, by setting the first connection surface 211 as an arc surface, compared with the first connection surface 211 of an inclined surface structure, when the fixing groove 2 is filled with insulating glue, the adhesive force of the insulating glue can be increased, and the assembly strength of the micro-electrostatic module core 1 and the frame body 3 can be increased.

In the ultra-thin micro-electrostatic module of some embodiments, as shown in FIG. 4, the micro-electrostatic module core 1 includes a first dust collecting surface 11 and a second dust collecting surface 13 that are oppositely arranged, and a plurality of air channels 10 for air circulation are penetrated between the first dust collecting surface 11 and the second dust collecting surface 13; The first dust collecting surface 11 protrudes from the frame 31 along the extending direction of the air channels 10. And/or, the second dust collecting surface 13 is arranged to protrude from the frame 31 along the extending direction of the air channels 10.

It can be understood that by adopting the assembly structure of the micro-electrostatic module core in the present application, the thickness of the micro-electrostatic module core can be adaptively thickened or the frame with smaller width specification can be used, so that the assembly of the micro-electrostatic module core can be stably realized, and the increase of the thickness of the micro-electrostatic module core can increase the length of the plurality of air channels, thereby increasing the dust collection efficiency of the micro-electrostatic module core 1.

In some embodiments, the single surface of the first dust collecting surface 11 or the second dust collecting surface 13 can be thickened by adopting the structural design of increasing the thickness of the core of the micro-electrostatic module.

In some embodiments, both the first dust collecting surface 11 and the second dust collecting surface 13 can be thickened by adopting the structural design that both sides of the micro-electrostatic module core are increased in thickness.

In the ultra-thin micro-electrostatic module of some embodiments, as shown in FIG. 4-6, the fixing component 4 includes an insulating glue 42, and the insulating glue 42 is filled between the frame 31 and the fixing groove 2.

Specifically, by filling the insulating glue 42 in the fixing groove 2, the frame 31 is firmly connected with the fixing groove 2, and at the same time, it plays a sealing role, preventing the problem that the edge of the fixing groove 2 and the conductive material 103 are too thin and too close to cause the conductive material to discharge, and improving the electrical safety.

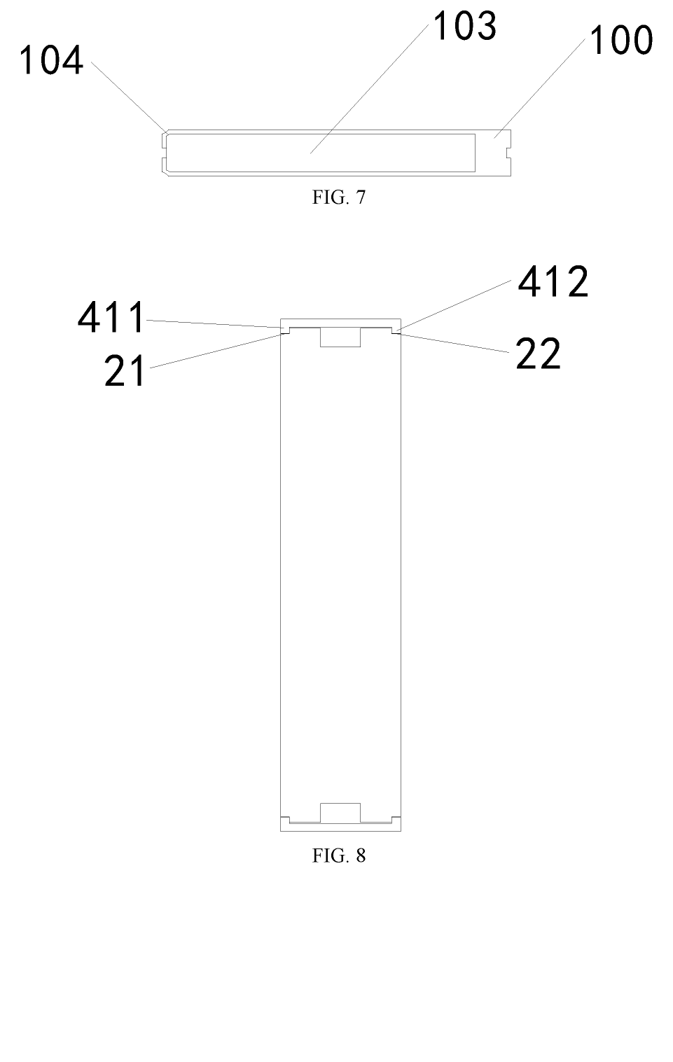

In the ultra-thin micro-electrostatic module of this embodiment, as shown in FIG. 7, the micro-electrostatic module core 1 includes a plurality of dust collecting sheets 100 and a plurality of spacers 101 arranged in a stacked arrangement, a plurality of air channels 10 are formed between the dust collecting sheets 100 and the spacers 101, and conductive materials 103 are wrapped in the dust collecting sheets 100, and the conductive materials 103 include avoidance grooves 104, which are arranged corresponding to the fixing grooves 2. It should be noted that the micro-electrostatic module forms an electrode plate by wrapping the conductive material 103 with a dielectric material, and captures charged particles in the air by using the strong electric field formed inside the electrode plate after the electrode plate is electrified.

Specifically, an electrode strip is installed in the electrode groove, and the electrode strip is electrically connected after contacting with the conductive material 103 located in the dust collecting sheet 100.

Specifically, after the fixing groove 2 is integrally formed on the micro-electrostatic module core 1, in order to prevent the distance between the fixing groove 2 and the conductive material inside the dust-collecting sheet from being too close, and to prevent the conductive material and the external conductor from discharging, the conductive material is adaptively shrunk, and an avoidance groove 104 is formed on the conductive material 103 to avoid the fixing groove 2, and the shape of the avoidance groove 104 is adapted to the shape of the fixing groove 2, so as to ensure that the distance between the edge of the conductive material 103 and the edge of the dust-collecting sheet conforms to the electrical safety distance. At the same time, in order to ensure the purification effect of the micro-electrostatic module, the larger the area of the conductive material 103, the greater the purification effect and dust holding capacity of the micro-electrostatic module. Therefore, the distance between the edge of the avoidance groove 104 and the edge of the dust collecting sheet is not less than the distance between the conductive material 103 at the non-avoidance groove 104 and the edge of the dust collecting sheet, thus ensuring electrical safety and maximizing the purification effect and dust holding capacity.

In the ultra-thin micro-electrostatic module of this embodiment, as shown in FIG. 7, the conductive material 103 is electrically connected with a high-voltage power supply through electrode strips, which is a high-voltage power supply installed in the frame body 3 or a high-voltage power supply installed outside the frame body 3.

In the charging device of this embodiment, the electrode body is connected with a high-voltage power supply, and the high-voltage power supply is an internal high-voltage power supply or an external high-voltage power supply.

Specifically, by adopting a built-in high-voltage power supply, a power supply bin is additionally arranged in any frame 31 of the frame body 3, and the high-voltage power supply is placed in the power supply bin, so the high-voltage power supply is needed because a strong electric field needs to be generated in the micro-electrostatic module. When the high-voltage power supply is external, the high-voltage electrode box is exposed to the air for a long time, which will lead to the electrode box creeping and arcing, thus affecting the discharge efficiency of the electrode head, and even leading to the damage of the charging device or the high-voltage power supply.The built-in power supply can improve the reliability of the charging device.

In the ultra-thin micro-electrostatic module of this embodiment, the frame body 3 includes a plurality of connecting components, which are respectively connected with two adjacent frames 31, so that the frames 31 are connected end to end. Specifically, the connecting components are corner tenons, and the assembly of a plurality of frames 31 is completed by a plurality of connecting components.

In the ultra-thin micro-electrostatic module of this embodiment, as shown in FIG. 1, there are a plurality of fixing components 4, and the fixing components 4 are arranged in one-to-one correspondence with the frames 31. Accordingly, a plurality of fixing grooves 2 are arranged.

It can be understood that each of the plurality of frames 31 is provide with a fixing component 4, and that micro-electrostatic module core 1 is provided with a corresponding fix groove 2, so that the assembling stability of the micro-electrostatic module core 1 and the frame body 3 is improved.

In the ultra-thin micro-electrostatic module of this embodiment, as shown in FIG. 8, the fixing components 4 includes a first fixing component 411 and a second fixing component 412 arranged at intervals, wherein the first fixing component 411 is connected with one end of the bezel 31, and the second fixing component 412 is connected with one end of the bezel 31 far from the first fixing component 411; The fixing groove 2 includes a first fixing groove 21 and a second fixing groove 22 which are arranged at intervals. The first fixing groove 21 is arranged corresponding to the first fixing component 411, and the second fixing groove 22 is arranged corresponding to the second fixing component 412. Specifically, the first dust collecting surface 11 and the second dust collecting surface 13 of the micro-electrostatic module core are both provided with the assembly structure in this embodiment, and the stability of the assembly of the micro-electrostatic module core 1 and the frame body 3 is improved through the above arrangement. It should be noted that the first fixing component 411, the second fixing component 412, the first fixing groove 21 and the second fixing groove 22 can be designed as a symmetrical structure or an asymmetrical structure. In the ultra-thin micro-electrostatic module of this embodiment, the fixing groove 2 includes the first fixing groove 21 opened on the leeward side of the micro-electrostatic module core 1, and the boss 41 is embedded in the first fixing groove 21 to support the micro-electrostatic module core 1.

Specifically, the first dust collecting surface 11 and the second dust collecting surface 13 of the micro-electrostatic module core are both provided with the assembly structure in this embodiment, and the stability of the assembly of the micro-electrostatic module core I and the frame body 3 is improved through the above arrangement.

It should be noted that the first fixing component 411, the second fixing component 412, the first fixing groove 21 and the second fixing groove 22 can be designed as a symmetrical structure or an asymmetrical structure.

In the ultra-thin micro-electrostatic module of this embodiment, the fixing groove 2 includes the first fixing groove 21 opened on the leeward side of the micro-electrostatic module core 1, and the boss 41 is embedded in the first fixing groove 21 to support the micro-electrostatic module core 1.

Specifically, the air first passes through the windward side and then passes through the leeward side of the micro-electrostatic module. In order to increase the structural strength of the micro-electrostatic module core, the fixing component adopts a boss structure design, that is, the first fixing groove 21 is formed on the leeward side of the micro-electrostatic module core 1, and the boss 41 is engaged with the first fixing groove 21, so that the micro-electrostatic module core is pressed against the boss structure by wind pressure, which plays a good supporting role, reduces the use of frame materials and reduces the difficulty of assembly, and can prevent the micro-electrostatic module core from being deformed and detached from the frame body 3, thus ensuring the assembly strength and stability of the micro-electrostatic module core.

### Embodiment 1

Referring to FIG. 2, the first fixing component 411, the second fixing component 412, the first fixing groove 21 and the second fixing groove 22 adopt symmetrical structural design, and the first fixing component 411 and the second fixing component 412 have a boss structure, and the first fixing groove 21 and the second fixing groove 22 include a first connection surface 211 and a second connection surface 212, the extending directions of the first connection surface 211 and the second connection surface 212 are perpendicular to each other.

It can be understood that with the above embodiment, the micro-electrostatic module core 1 is locked and fixed by the bosses on both sides, and the support strength of the frame body 3 for the micro-electrostatic module core 1 is high at this time.

### Embodiment 2

Referring to FIG. 3, the first fixing component 411, the second fixing component 412, the first fixing groove 21 and the second fixing groove 22 adopt symmetrical structural design. The first fixing component 411 and the second fixing component 412 have a boss structure, and the first fixing groove 21 and the second fixing groove 22 include a first connection surface 211 and a second connection surface 212, and the second connection surface 212 is an arc surface.

It can be understood that with the above embodiment, the insulating glue can be continuously filled in the fixing groove to increase the fixing strength and sealing performance of the micro-electrostatic module core 1, and at this time, the supporting strength of the frame body 3 to the micro-electrostatic module core 1 is higher.

### Embodiment 3

Referring to FIG. 4, the first fixing component 411, the second fixing component 412, the first fixing groove 21 and the second fixing groove 22 adopt asymmetric structural design. The first fixing component 411 is made of insulating glue, and the second fixing component 412 has a boss structure. The first fixing groove 21 is an inclined surface, and the second fixing groove 22 includes a first connection surface 211 and a second connection surface 212, and the second connection surface 212 is an arc surface.

It can be understood that when the above embodiment is adopted, the structure that the boss is engaged with the fixing groove on the leeward side can play a good supporting role.

Preferably, the thickness of the first dust collecting surface 11 is thickened to increase the dust collecting efficiency of the micro-electrostatic module core. At this time, the first fixing groove 21 is designed as an inclined surface, which can reduce the occupied area of the first fixing groove 21 and increase the dust containing surface of the micro-electrostatic module core 1.

### Embodiment 4

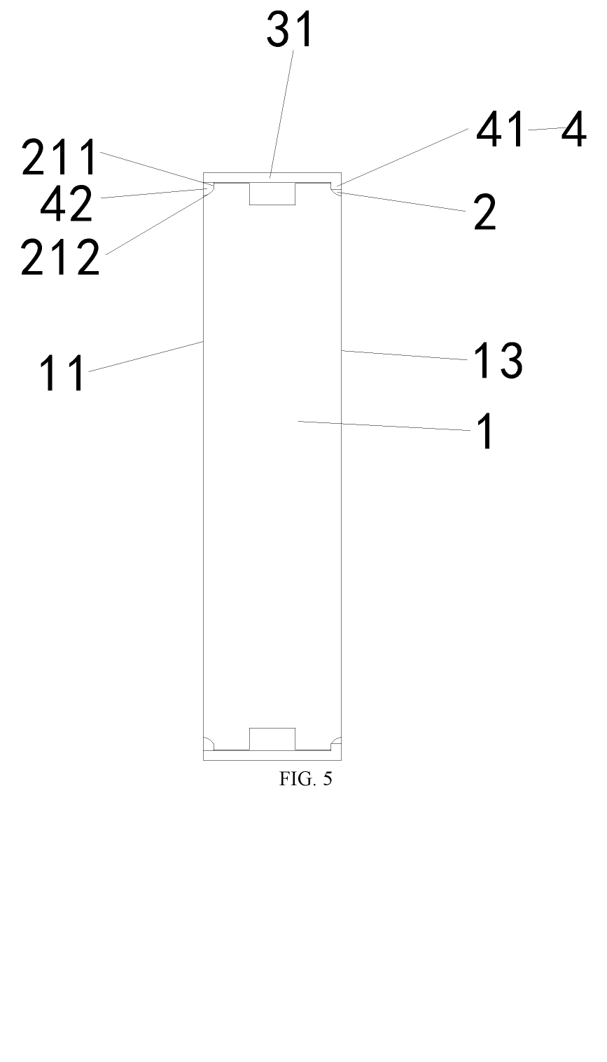

Referring to FIG. 5, the first fixing component 411 and the second fixing component 412 adopt asymmetric structural design, and the first fixing groove 21 and the second fixing groove 22 adopt symmetrical structural design. The first fixing component 411 is made of insulating glue, and the second fixing component 412 has a boss structure. The first fixing groove 21 and the second fixing groove 22 include a first connection surface 211 and a second connection surface 212, and the second connection surface 212 is an arc surface.

It can be understood that when the above embodiment is adopted, the structure that the boss is engaged with the fixing groove on the leeward side can play a good supporting role.

It can be understood that when the above embodiment is adopted, the second fixing groove 22 can also be filled with insulating glue continuously, and both the first fixing groove and the second fixing groove are filled with insulating glue, which can increase the sealing performance of the micro-electrostatic module core.

### Embodiment 5

Referring to FIG. 6, the first fixing component 411, the second fixing component 412, the first fixing groove 21 and the second fixing groove 22 adopt symmetric structural design, and the first fixing component 411 and the second fixing component 412 are made of insulating glue, and the first fixing groove 21 and the second fixing groove 22 include a first connection surface 211, and the first connection surface 211 is an arc surface.

It can be understood that when the above-mentioned embodiment is adopted, the dust collecting surfaces on both sides of the micro-electrostatic module core 1 are designed without bosses, and at this time, the thickness of the frame is the thinnest, and the dust containing surface of the micro-electrostatic module core 1 reaches the maximum.

In the production method of this embodiment, referring to FIG. 1, the production method is suitable for the ultra-thin micro-electrostatic module, and the production method includes: obtaining a micro-electrostatic module core 1; Machining a fixed groove 2 on the micro-electrostatic module core 1, and melting is generated in the fixed groove 2 through a high temperature generated in the machining process; connecting a plurality of frames 31 with the micro-electrostatic module core 1 correspondingly in turn; embedding the fixing component 4 in the fixing groove 2; and completing the assembly of the ultra-thin micro-electrostatic module.

In some embodiments, after the micro-electrostatic module core 1 is integrally molded, the fixing groove 2 is processed, and the high temperature generated in the processing process causes melting in the fixing groove 2. After the fixing groove 2 is processed, the frames 31 are connected with the micro-electrostatic module core 1 one by one, so that the bosses 41 are locked in the corresponding fixing grooves 2, and the connecting components are connected with the frames 31, thereby completing the assembly of the ultra-thin micro-electrostatic module.

In some embodiments, after the micro-electrostatic module core 1 is integrally molded, the fixing groove 2 is processed, and after the fixing groove 2 is processed, the frames 31 are connected with the micro-electrostatic module core 1 one by one, the connecting components are connected with each frame 31, and the insulating glue is filled in the fixing groove 2, thus completing the assembly of the ultra-thin micro-electrostatic module.

The ultra-thin micro-electrostatic module of this embodiment solves the sealing problem of the micro-electrostatic module by adopting the thermal cutting process, and the high temperature generated in the processing process makes the fixing groove 2 melt, and the micro-electrostatic module core 1 is hot-melted and liquefied to form a curling edge. After cooling, the cutting edges of the layers are blended, so that the conductive material 103 can be completely coated without being damaged, thereby generating a sealing effect between the dust collecting pieces of the micro-electrostatic module core 1, avoiding the occurrence of electrical safety problems and ensuring the ideal waterproof effect of the ultra-thin micro-electrostatic module of this embodiment.

In some embodiments, when the frame 31 is fixed to the micro-electrostatic module core 1, a layer of colloid can be coated around the inside of the frame 31 or along the first side wall 12 of the micro-electrostatic module core to increase the firmness and sealing of the connection between the frame 31 and the micro-electrostatic module core 1.

In the production method of some embodiments, referring to FIG. 1, the method of processing the fixing groove 2 on the micro-electrostatic module core 1 includes fixing the micro-electrostatic module core 1 on a thermal cutting device, and processing the fixing groove 2 through thermal cutting.

Specifically, the edge of the core body of the micro-electrostatic module 1 is melted and cut by the directional movement of the electrode wire, and seals are formed between adjacent stacked separators after melting and cutting, so that the conductive materials are completely sealed in the separators, thus ensuring that the ultra-thin micro-electrostatic module of this embodiment can be washed and soaked repeatedly.

The above is only the preferred embodiment of the present application. If the scope of implementation of the present application cannot be limited, that is, all the equal changes and modifications made according to the scope of this application should still fall within the scope of the present application.

What is claimed is:

1. An ultra-thin micro-electrostatic module, comprising:
a micro-electrostatic module core, wherein the micro-electrostatic module core comprises a plurality of air channels for air circulation and is provided with a fixing groove;
a frame body comprising a plurality of frames arranged corresponding to the micro-electrostatic module core, wherein the micro-electrostatic module core is accommodated in the frame body; and
a fixing component, wherein the fixing component is embedded in the fixing groove, and is connected with the frame body and the micro-electrostatic module core to fix the micro-electrostatic module core.

2. The ultra-thin micro-electrostatic module of claim 1, wherein the fixing component comprises a boss integrally formed with the frames, and the boss extends in a direction close to the micro-electrostatic module core and is embedded in the fixing groove.

3. The ultra-thin micro-electrostatic module of claim 1, wherein the fixing groove comprises a first connection surface and a second connection surface connected with the first connection surface, and the extending directions of the first connection surface and the second connection surface are perpendicular to each other; or the second connection surface is an arc surface.

4. The ultra-thin micro-electrostatic module of claim 1, wherein the fixing groove comprises a first connection surface, and the first connection surface is an inclined surface; or the first connecting surface is an arc surface.

5. The ultra-thin micro-electrostatic module of claim 1, wherein the micro-electrostatic module core comprises a first dust collecting surface and a second dust collecting surface arranged oppositely, and a plurality of air channels for air circulation are arranged between the first dust collecting surface and the second dust collecting surface;
the first dust collecting surface is arranged to protrude from one of the plurality of frames along extending direction of the plurality of air channels; and/or the second dust collecting surface is arranged to protrude from the plurality of frames along the extending direction of the plurality of air channels.

6. The ultra-thin micro-electrostatic module of claim 1, wherein the fixing component comprises an insulating glue, and the insulating glue is filled between one of the plurality of frames and the fixing groove.

7. The ultra-thin micro-electrostatic module of claim 1, wherein the micro-electrostatic module core comprises a plurality of dust collecting sheets in a stacked arrangement and a plurality of spacers, each of the plurality of spacers is arranged between two of the plurality of dust collecting sheets, the plurality of air channels are formed between the dust collecting sheets and the plurality of spacers, one of the dust collecting sheets is wrapped with a conductive material, the conductive material comprises an avoidance groove, and the avoidance groove is arranged corresponding to the fixing groove.

8. The ultra-thin micro-electrostatic module of claim 7, wherein the conductive material is electrically connected to a high-voltage power supply through a electrode strip, and the high-voltage power supply is installed inside the frame body or outside the frame body.

9. The ultra-thin micro-electrostatic module of claim 1, further comprising a plurality of fixing components, wherein the plurality of fixing components is arranged corresponding to the plurality of frames; and
a plurality of fixing grooves.

10. The ultra-thin micro-electrostatic module of claim 9, wherein the plurality of fixing components comprises a first fixing component and a second fixing component arranged at intervals, and the first fixing component is connected with an end of one of the plurality of frames, and the second fixing component is connected with an end of one of the plurality of frames far away from the first fixing component; and the fixing groove comprises a first fixing groove and a second fixing groove arranged at intervals, and the first fixing groove is arranged corresponding to the first fixing component, and the second fixing groove is arranged corresponding to the second fixing component.

11. The ultra-thin micro-electrostatic module of claim 2, wherein the fixing groove comprises a first fixing groove arranged on a leeward surface of the micro-electrostatic module core, and the boss is embedded in the first fixing groove to support the micro-electrostatic module core.

12. A production method, wherein the production method is suitable for the ultra-thin micro-electrostatic module according to claim 1 and the production method comprises:
obtaining a micro-electrostatic module core;
machining a fixed groove on the micro-electrostatic module core, and melting is generated in the fixed groove through a high temperature generated in the machining process;
connecting a plurality of frames with the micro-electrostatic module core correspondingly in turn;
embedding the fixing component in the fixing groove; and
completing the assembly of the ultra-thin micro-electrostatic module.

13. The production method of claim 12, wherein machining a fixed groove on the micro-electrostatic module core comprises:
fixing the micro-electrostatic module core on a thermal cutting device; and
processing the fixing groove through thermal cutting.
